(19) United States
(12) Patent Application Publication
(10) Pub. No.: US 2024/0216855 A1
(43) Pub. Date: Jul. 4, 2024

(54) DEVICE FOR PURIFYING GAS, POSITIONING ELEMENT AND METHOD FOR ASSEMBLING A DEVICE FOR PURIFYING GAS USING SUCH A POSITIONING ELEMENT

(71) Applicant: ATLAS COPCO AIRPOWER, NAAMLOZE VENNOOTSCHAP, Wilrijk (BE)

(72) Inventors: Julien COUSIN-SAINT-REMI, Wilrijk (BE); Wouter FOLLON, Wilrijk (BE)

(73) Assignee: ATLAS COPCO AIRPOWER , NAAMLOZE VENNOOTSCHAP, Wilrijk (BE)

(21) Appl. No.: 18/289,156

(22) PCT Filed: Apr. 22, 2022
(86) PCT No.: PCT/EP2022/060731

§ 371 Date: Nov. 1, 2023

(30) Foreign Application Priority Data
May 3, 2021 (BE) BE2021/5351

(51) Int. Cl. B01D 53/26; B01D 53/04; B01J 20/28

(52) U.S. Cl. CPC B01D 53/261; B01D 53/0423; B01J 20/28052; B01D 2253/342

(57) ABSTRACT

A device for purifying gas, the device (1) substantially comprising at least one vessel (2) having an inlet (3) for gas to be purified and an outlet (4) for purified gas, two or more blocks (5) of a purifying agent being arranged in the vessel (2), which blocks are stacked on top of each other, characterized in that a positioning element (8) is arranged between two consecutive blocks (5), which positioning element is provided with at least one pin (9) on both sides of the positioning element (8), which pin is arranged in an opening (10) provided in the blocks (5) for this purpose, the positioning element (8) being located completely within the outer circumference (11) of the blocks (5).

### BACKGROUND OF THE INVENTION

### Field

The present invention relates to a device for purifying gas.

In particular, the invention relates to a device for purifying gas, which device comprises at least one vessel having an inlet for gas to be purified and an outlet for purified gas.

### Background

In this case, “purifying gas” means that the gas is purified by another gas, a liquid or another substance that is extracted from the gas to be purified.

A purifying agent is arranged in the vessel.

This purifying agent can take different forms, for example grains or a structured material in the form of one or more blocks. Said blocks are typically stacked on top of each other.

The purifying agent can be, for example, a drying agent, also referred to as a desiccant, the gas to be purified being dried and water vapor being separated from the gas by the drying agent. This conventionally occurs, for example, in the case of compressed gas originating from a compressor, it being necessary for the compressed gas to be free of moisture before it is discharged to the users.

It can of course not be ruled out that another type of purifying agent is used instead of a drying agent. For example, this can be a purifying agent in which gas can be purified from a mixture of gases, as is typically the case with gas generators.

The blocks of purifying agent or drying agent conventionally have a shape that is complementary to the shape of the vessel in which they are stacked.

The blocks have cavities, channels and the like through which the gas to be purified can flow.

In WO2017/035607, such blocks are anchored when stacked on top of each other using seals arranged around the blocks in the location where two blocks are stacked on top of each other, the seal having an inwardly protruding lip that reaches between the blocks.

The seal anchors two consecutive blocks on top of each other, the protruding lip keeping the blocks at a distance from one another.

Because the geometry and the location of the aforementioned cavities, channels and the like differ from the various blocks, it is necessary to keep the blocks at a distance from one another so that one block cannot seal off the channels of the other block.

One disadvantage of such a design is that the protruding lip seals off a significant portion of the surface of the blocks through which the gas must flow, as a result of which it is not possible to use the entire volume of the blocks.

Moreover, the seals create a roughness or irregularity across the outer surface of the stacked blocks.

This has the disadvantage that a casing, such as a film, tape or shrink sleeve, which is arranged around the circumferential wall of the stack of blocks, cannot make very good contact with the stacked blocks as a result of said roughness.

The use of tape as a casing is described in US2016/0236135A1.

Leaks can occur if the casing cannot connect properly to the circumferential wall. Such leaks are of course undesirable because they cause non-purified or incompletely purified gas to escape, which results in contamination of the purified gas that leaves the device.

### SUMMARY OF THE INVENTION

This invention aims at solving at least one of the aforementioned and other disadvantages.

The present invention relates to a device for purifying gas, the device substantially comprising a vessel having an inlet for gas to be purified and an outlet for purified gas, two or more blocks of a purifying agent being arranged in the vessel, which blocks are stacked on top of each other, characterized in that a positioning element is arranged between two consecutive blocks, which positioning element is provided with at least one pin on both sides of the positioning element, which pin is arranged in an opening provided in the blocks for this purpose, the positioning element being located completely within the outer circumference of the blocks.

One advantage is that the positioning element having the pins allows the blocks stacked on top of each other to be anchored to each other.

Because the pins protrude into the blocks, they are anchored with respect to each other, i.e., kept in place by the pins in the horizontal direction.

The positioning element between two consecutive blocks serves as a kind of spacer so that the blocks are kept at a distance from each other in the vertical direction.

Because the positioning element is located within the outer circumference of the blocks, the circumferential wall of the stacked blocks is completely flat, such that a shrink sleeve, which is arranged around the stacked blocks, can make full and good contact with said circumferential wall such that leaks can be prevented.

Moreover, the dimension of the stack is not increased in the radial direction due to protruding parts of the positioning element, as a result of which the device can be made as compact as possible.

The aforementioned pin can be designed in many ways. The pin can be hollow or solid. The pin can be open at its ends and can take various forms: cylindrical, cube, pyramid, etc.

In the most preferred embodiment, the positioning element comprises one frame-shaped spacer having two or more pins on both sides.

In this case, “frame shape” means that the spacer is a narrow strip that follows the shape of the cross section of the blocks. The ring shape can be round if the blocks have a round cross section, but can also be rectangular or square.

It is known that the blocks traditionally have a round cross section. Such a round frame-shaped or thus ring-shaped spacer can in this case support the blocks around their circumference, while the pins anchor or hold the blocks.

By matching the dimensions of the frame-shaped spacer or the diameter in the case of a ring-shaped spacer with the dimensions or diameter of the blocks, it can be ensured that the outer dimensions or outer diameter of the frame-shaped or ring-shaped spacer matches the outer dimensions or the outer diameter of the blocks, such that the blocks are supported along their outer diameter.

As a result of this, a very stable stack can be achieved.

Furthermore, the frame-shaped spacer can also be designed to be very slim in the radial direction, such that only a very limited surface of the blocks is blocked by the frame-shaped spacer.

Furthermore, such a frame-shaped spacer also prevents the blocks from tilting relative to each other.

By providing at least two pins on each side, the blocks cannot rotate with respect to each other along an axis parallel to the axial direction of the stacked blocks.

In a practical embodiment, the frame-shaped spacer has an open frame shape.

This means that the frame is interrupted over a distance, which is preferably limited.

This has the advantage that even less of the surface of the blocks is blocked without having to compromise on the stability of the stacked blocks as a result.

However, according to the invention it is not necessary for the positioning element to have a frame-shaped spacer.

After all, it is possible for the positioning element to comprise two or more spacers of any shape having one or more pins on both sides.

By suitably positioning the spacers, a stable stack can be made.

Furthermore, the surface that the spacers block can also be kept very limited in this manner.

The fewer channels, cavities and the like that are blocked by the spacers, the more volume of the blocks can be used to purify gas.

In a practical embodiment, the outermost blocks of the blocks of a purifying agent stacked on top of each other, i.e., the uppermost and lowermost blocks, are provided with a positioning element on their free side, which positioning element is provided on one side with at least one pin that is arranged in an opening in the blocks provided for this purpose.

Such a positioning element is thus identical to the aforementioned positioning element, but it is provided with a pin on only one side.

The invention also relates to a positioning element to be arranged between two blocks of a purifying agent stacked on top of each other, the positioning element being provided with at least one pin on both sides of the positioning element, which pin can be arranged in an opening in the blocks provided for this purpose, the positioning element being located completely within the outer circumference of the blocks.

The invention further relates to a method for assembling a device for purifying gas using a positioning element, the method comprising the following steps:
providing a device having at least one vessel having an inlet for gas to be purified and an outlet for purified gas;
providing two or more blocks of a purifying agent;
providing one or more positioning elements, the positioning element being provided with at least one pin on both sides of the positioning element;
arranging a block of a purifying agent in the at least one vessel;
arranging a positioning element on the block of a purifying agent, ensuring that the at least one pin of the positioning element is arranged in an opening in the block of a purifying agent provided for this purpose and ensuring that the positioning element is located completely within the outer circumference of the blocks;
arranging a further block of a purifying agent in the at least one vessel by stacking said further block on the block of a purifying agent already placed in the vessel, ensuring that the at least one pin of the positioning element, which pin is still exposed, is arranged in an opening in the further block of a purifying agent provided for this purpose;
repeating the previous two steps until all the blocks of a purifying agent are arranged in the at least one vessel.

### BRIEF DESCRIPTION OF THE DRAWINGS

To better demonstrate the characteristics of the invention, the following describes, by way of example without any restrictive character, a number of preferred embodiments of a device for purifying gas, a positioning element and a method for assembling a device for purifying gas using such a positioning element according to the invention, with reference to the accompanying drawings, in which:

FIG. 1 schematically shows an arrangement according to the invention;

FIG. 2 shows a practical embodiment of the portion indicated in FIG. 1 by F2;

FIGS. 3A and 3B show a practical embodiment of the positioning element in FIGS. 1 and 2;

FIGS. 4 to 10 show alternative embodiments of FIGS. 3A and 3B.

### DETAILED DESCRIPTION

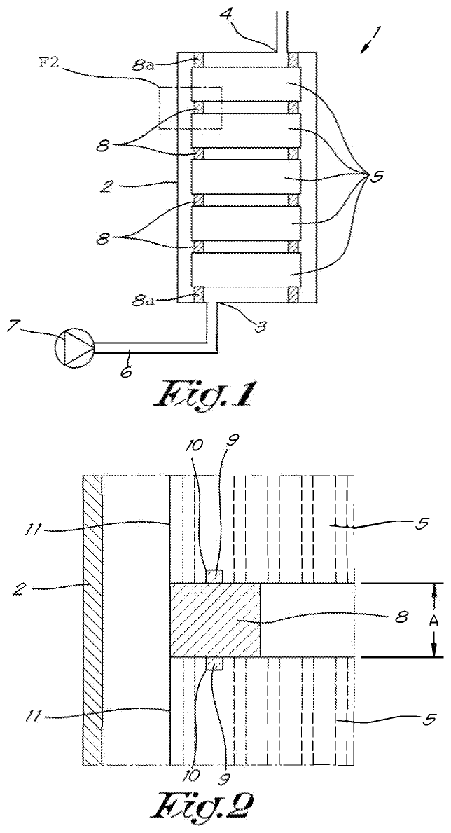

The device 1 for purifying gas shown schematically in FIG. 1 substantially comprises a vessel 2 having an inlet 3 for gas to be purified and an outlet 4 for purified gas.

Although only one vessel 2 is shown in the figure, it cannot be ruled out that the device 1 comprises a plurality of vessels 2.

A number of blocks 5 of a purifying agent, in this case five, are arranged in the vessel 2, which blocks are stacked on top of each other.

In this case, the blocks 5 have a cylindrical design. It is also possible for the blocks to have a beam-shaped or cube-shaped design.

As is shown in FIG. 1, the inlet 3 is, in this case, but not necessary for the invention, connected to the inlet 6 of a compressor 7.

The aforementioned purifying agent is, in this case, but not necessary for the invention, a drying agent, also referred to as a desiccant.

The device 1 dries the compressed gas of the compressor 7.

However, the invention can also be used, for example, to purify gas from another contaminated gas at atmospheric pressure or subatmospheric pressure or under vacuum.

A positioning element 8 is arranged between two consecutive blocks 5.

The purpose of said positioning element 8 is to position or anchor the blocks 5 with respect to each other so that they cannot move. Furthermore, it serves as a spacer to keep the blocks 8 at a distance A from each other.

The precise or exact embodiment of said positioning element 8 can differ, but what they all have in common is that they are provided with at least one pin 9 on both sides of the positioning element 8, which pin is arranged in an opening 10 in the blocks 5 provided for this purpose, and that the positioning element 8 is located completely within the outer circumference or circumferential wall 11 of the blocks 5.

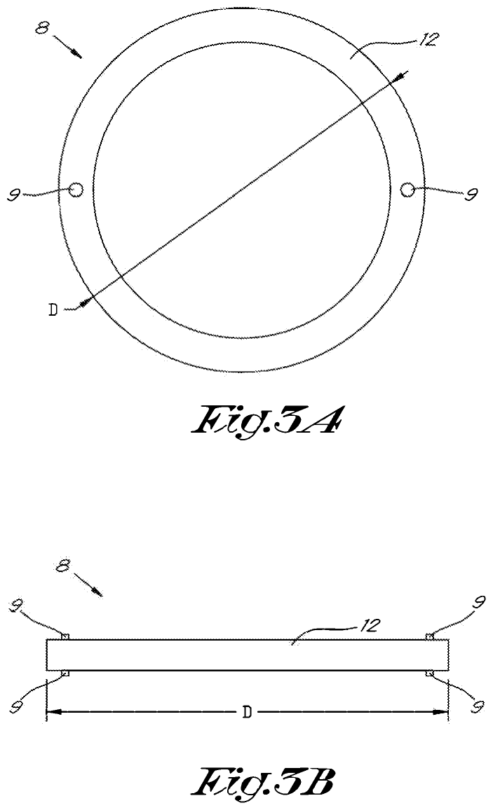

This is shown in FIG. 2.

The openings 10 in the blocks 5 can be formed by the channels, cavities or the like of the blocks 5 or can be specially arranged in said blocks 5. The aforementioned channels, cavities and the like are shown in FIG. 2 by means of dotted lines.

The shape of the pins 9 can vary. As already mentioned, the aforementioned pin 9 can be designed in many ways. The pin 9 can be hollow or solid. The pin 9 can be open at its ends and can take various forms: cylindrical, cube, pyramid, etc.

As shown in FIG. 1, a positioning element 8 is also provided on the two outermost blocks 5, on the side of said outermost blocks 8 facing away from the other blocks 5.

Such a positioning element 8a is provided on only one side with at least one pin 9 that is arranged in an opening 10 in the respective blocks 5 provided for this purpose. The positioning element 8a is located completely within the outer circumference or circumferential wall 11 of the blocks 5.

Said positioning element 8a ensures the positioning of the stacked blocks 5 in the vessel 2 so that the outermost blocks 5 do not make contact with the walls of the vessel 2.

The positioning element 8 can be made of one material, for example metal, such as aluminum, or from a polymer or a combination of such materials.

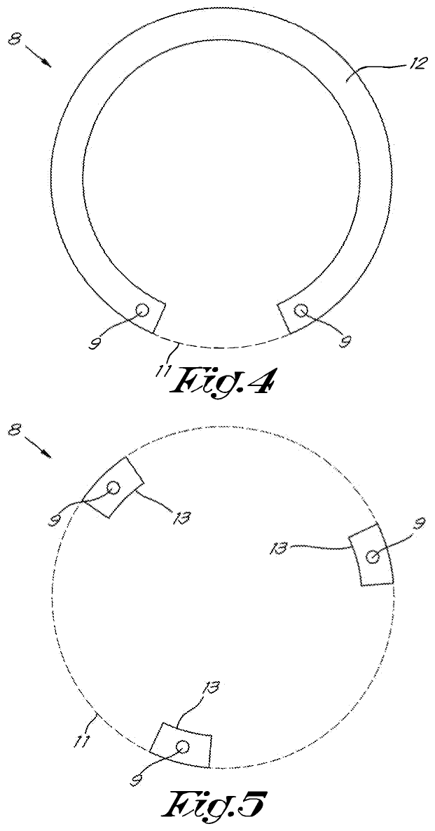

In FIGS. 3A and 3B, a positioning element 8 from FIGS. 1 and 2 is included.

The positioning element 8 comprises one ring-shaped spacer 12 having in this case two pins 9 on both sides.

Although in this case reference is made to a ring-shaped spacer 12, the invention is of course not limited thereto. If the blocks 5 are, for example, cube-shaped, the spacer 12 will have a square frame shape.

The diameter D of the ring-shaped spacer 12 corresponds to the diameter of the blocks 5 and its outer diameter matches the outer diameter of the blocks 5, as can be seen clearly in FIG. 2.

If the blocks 5 are cube-shaped, the dimensions of the frame-shaped spacer will correspond to the dimensions of the blocks 5 and the outer dimensions of the frame-shaped spacer will match the outer dimensions of the blocks.

The ring-shaped spacer 12 has a relatively slim design in its radial direction, such that only a limited surface of the blocks 5 is covered by the ring-shaped spacer 12.

When the blocks 5 are stacked, a ring-shaped spacer 12 is arranged on a block 5 in each case.

The pins 9 are in this case arranged in the openings 10 provided for this purpose.

The next block 5 is then arranged with its openings 10 on the exposed pins 9 of the ring-shaped spacer 12.

Because of the pins 9, the block 5 is automatically aligned correctly with the underlying block 5.

The ring-shaped spacer 12 also ensures that the next block 5 will be at a distance A from the underlying block 5, such that the blocks 5 do not touch each other and can therefore seal off their cavities, channels and the like. Furthermore, the mutual distance between the blocks 5 is also necessary to be able to redistribute the gas when it flows from one block 5 to the other block 5.

It cannot be ruled out that a shrink sleeve or another casing such as tape or film is arranged over the circumferential wall 11 of at least a portion of the blocks 5 of a purifying agent stacked on top of each other.

Said shrink sleeve preferably consists of an elastic material with low gas permeability, such as polyolefin.

Because the positioning element 8 is located completely within the outer circumference or circumferential wall 11 of the blocks 5, the shrink sleeve will be able to fit snugly anywhere on the blocks 5 when applied.

The operation of the device 1 is very simple and as follows.

The gas compressed by the compressor 7 reaches the inlet 3 via the vessel 2.

The compressed gas flows through the blocks 5 of the drying agent, as a result of which the moisture that is present in the gas is absorbed by the drying agent.

The dried gas leaves the vessel 2 via the outlet 4.

To assemble such a device 1 using a positioning element 8, the following method is applied.

The method starts with the device 1 having at least one vessel 2, a number of blocks 5 of a purifying agent and a number of positioning elements 8.

First, one of the blocks 5 is arranged in the vessel 2, after which one of the positioning elements 8 is then arranged on said block.

In this case, care is taken to ensure that the pin 9 or pins 9 are arranged in the openings in the block 5 provided for this purpose.

In this case, the positioning element will fall completely within the outer circumference 11 of the blocks 5.

Then, a next block 5 can be arranged in the vessel 2 by stacking it on the block 5 already present in the vessel 2.

In this case, care is taken to ensure that the pin 9 or pins 9 of the positioning element 8, which pin or pins is/are still exposed, are arranged in the openings of the next block 5 provided for this purpose.

The next positioning elements 8 and blocks 5 are arranged analogously in the vessel 2 until all blocks 5 are arranged in the vessel 2.

A number of variants are shown in FIGS. 4 to 10.

In FIG. 4, a variant is shown in which the ring-shaped spacer 12 has an open ring shape. In this way, even less of the surface of the blocks 5 is covered by the ring-shaped spacer 12.

In the case of a frame-shaped spacer, said spacer can analogously also have an open frame shape, the frame being interrupted over a certain distance.

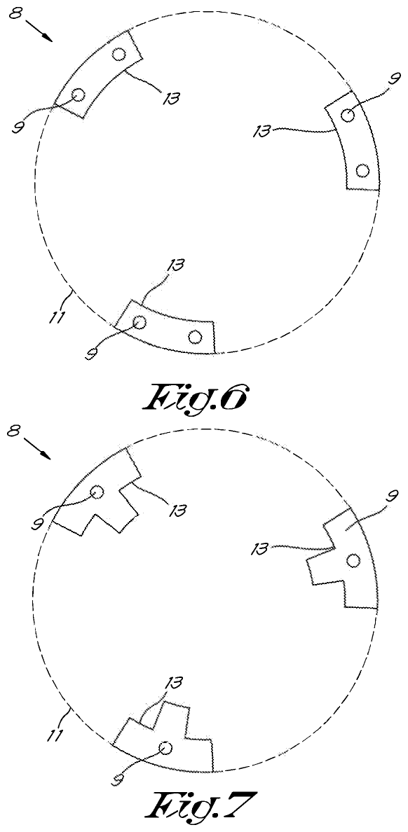

In FIG. 5, the positioning element 8 then comprises three spacers 13 having one pin 9 on both sides. In the variant of FIG. 6, each spacer 13 has two pins 9 on both sides.

The spacers 13 of the positioning element 8 are in both cases evenly distributed along the circumferential wall 11 of the blocks 5.

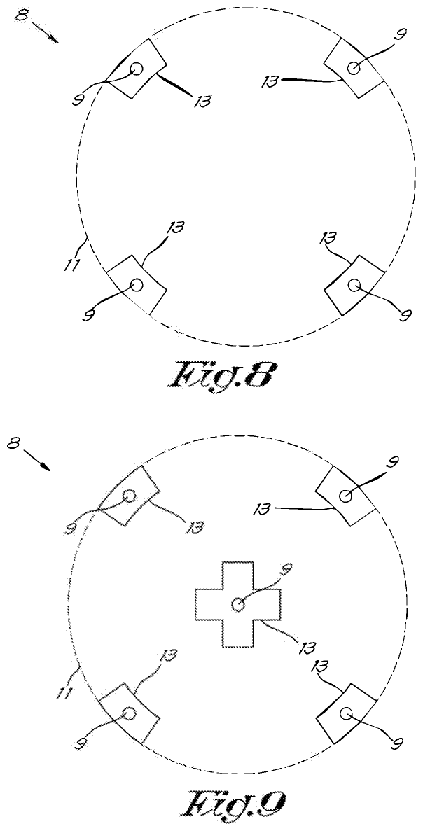

FIG. 7 shows by way of illustration another variant in which the shape of the spacers 13 is changed to a T-shape to show that there is a great degree of freedom when it comes to choosing the shape.

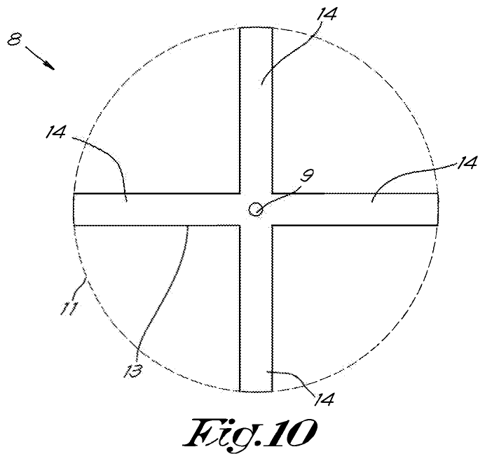

In FIGS. 8 and 9, the positioning element 8 comprises four spacers 13, which are evenly distributed along the circumferential wall 11 of the block 5.

The spacers 13 are now comparable in size to the dimensions of the pin 9, each spacer 13 being provided with one pin 9 on both sides.

Additionally, in FIG. 9, a spacer 13 is placed centrally between two blocks 5, which means that said spacer 13 is placed in the center of the block 5.

This ensures that the center of the block 5 is supported and prevents the block 5 from sagging and becoming deformed when it rests with its outer circumference 11 on the four other spacers 13.

Finally, FIG. 10 shows a positioning element 8 that comprises a circular spacer 13 having, in this case, four arms 14 having one centrally located pin 9 on each side.

It is also possible for three or more than four arms 14 to be provided.

In this case, the aforementioned arms 14 have an equal length.

The examples shown in FIGS. 3A to 10 show that the positioning element 8 or the spacers 12, 13 of the positioning element 8 can be designed in different ways.

However, all of them meet the conditions that they are provided with at least one pin 9 on both sides of the positioning element 8, which pin is arranged in an opening 10 in the blocks 5 provided for this purpose, and that the positioning element 8 is located completely within the outer circumference 11 of the blocks 5.

It is clear that all the aforementioned variants of the positioning element 8 can also be applied mutatis mutandis to the positioning element 8a.

The present invention is by no means limited to the embodiments described as examples and shown in the figures, but a device for purifying gas, a positioning element and a method for assembling a device for purifying gas using such a positioning element according to the invention can be implemented in all variants without going beyond the scope of the invention.

1. A device for purifying gas, the device (1) substantially comprising at least one vessel (2) having an inlet (3) for gas to be purified and an outlet (4) for purified gas, two or more blocks (5) of a purifying agent being arranged in the vessel (2), which blocks are stacked on top of each other, characterized in that a positioning element (8) is arranged between two consecutive blocks (5), which positioning element is provided with at least one pin (9) on both sides of the positioning element (8), which pin is arranged in an opening (10) provided in the blocks (5) for this purpose, the positioning element (8) being located completely within the outer circumference (11) of the blocks (5).

2. The device according to claim 1, characterized in that the positioning element (8) comprises two or more spacers (13) having one or more pins (9) on both sides.

3. The device according to claim 2, characterized in that the spacers (13) of the positioning element (8) are evenly distributed along the circumferential wall (11) of the blocks (5).

4. The device according to claim 2, characterized in that one of the aforementioned spacers (13) placed centrally between two blocks (5).

5. The device according to claim 1, characterized in that the positioning element (8) comprises one ring-shaped or frame-shaped spacer (12) having two or more pins (9) on both sides.

6. The device according to claim 5, characterized in that the ring-shaped or frame-shaped spacer (12) has an open ring shape or frame shape.

7. The device according to claim 1, characterized in that the positioning element (8) comprises a circular spacer (13) having three or more arms (14) having one centrally located pin (9) on each side.

8. The device according to claim 7, characterized in that the aforementioned arms (14) have an equal length.

9. The device according to claim 1, characterized in that the outermost blocks (5) of the blocks of a purifying agent stacked on top of each other are provided with a positioning element (8) on their free side, which positioning element is provided on one side with at least one pin (9) that is arranged in an opening (10) in the blocks (5) provided for this purpose.

10. The device according to claim 1, characterized in that the positioning element (8) is made of one material, such as metal or a polymer or of a combination of materials.

11. The device according to claim 1, characterized in that a casing is arranged over the circumferential wall (11) of at least a portion of the blocks (5) of a purifying agent stacked on top of each other.

12. The device according to claim 1, characterized in that the purifying agent is a drying agent or desiccant.

13. The device according to claim 1, characterized in that the inlet (3) is connected to the outlet (6) of a compressor (7).

14. A positioning element to be arranged between two blocks (5) of a purifying agent stacked on top of each other, the positioning element (8) being provided with at least one pin (9) on both sides of the positioning element (8), which pin can be arranged in an opening in the blocks (5) provided for this purpose, the positioning element (8) being located completely within the outer circumference (11) of the blocks (5).

15. A method for assembling a device for purifying gas using a positioning element, the method comprising the following steps:
providing a device having at least one vessel (2) having an inlet (3) for gas to be purified and an outlet (4) for purified gas;
providing two or more blocks (5) of a purifying agent;
providing one or more positioning elements (8), the positioning element (8) being provided with at least one pin (9) on both sides of the positioning element (8);
arranging a block (5) of a purifying agent in the at least one vessel (2);
arranging a positioning element (8) on the block (5) of a purifying agent, ensuring that the at least one pin (9) of the positioning element (8) is arranged in an opening in the block (5) of a purifying agent provided for this purpose and ensuring that the positioning element (8) is located completely within the outer circumference (11) of the blocks (5);
arranging a further block (5) of a purifying agent in the at least one vessel (2) by stacking said further block on the block (5) of a purifying agent already placed in the vessel (2), ensuring that the at least one pin (9) of the positioning element (8), which pin is still exposed, is arranged in an opening in the further block (5) of a purifying agent provided for this purpose;
repeating the previous two steps until all the blocks (5) of a purifying agent are arranged in the at least one vessel (2).
